(19) United States
(12) Patent Application Publication
(10) Pub. No.: US 2014/0263193 A1
(43) Pub. Date: Sep. 18, 2014

(54) CONSUMABLE AND METHOD AND SYSTEM TO UTILIZE CONSUMABLE IN A HOT-WIRE SYSTEM

(71) Applicant: LINCOLN GLOBAL, INC., City of Industry, CA (US)

(72) Inventors: Paul E. Denney, Bay Village, OH (US); Steven R. Peters, Huntsburg, OH (US)

(73) Assignee: LINCOLN GLOBAL, INC., City of Industry, CA (US)

(21) Appl. No.: 13/835,224

(22) Filed: Mar. 15, 2013

(51) Int. Cl. B23K 35/02; B23K 35/24

(52) U.S. Cl. CPC B23K 35/0261; B23K 35/24
USPC 219/76.1; 219/145.41

(57) ABSTRACT

A method and system to weld or overlay workpieces employing a high intensity energy source to create a puddle and at least one resistive filler wire which is heated to at or near its melting temperature and deposited into the weld puddle. The filler wire comprises a core and an electrically conductive outer matrix having particles to be deposited into the puddle.

### INCORPORATION BY REFERENCE

The present invention generally relates to improvements methods and systems described in U.S. patent application Ser. No. 13/547,649 filed on Jul. 12, 2012, the entire disclosure of which is incorporated herein by reference, in its entirety.

### TECHNICAL FIELD

Certain embodiments relate to consumables, and methods and systems for using the consumables in joining, overlaying and cladding operations. More particularly, certain embodiments relate to consumables having a particular configuration and methods and systems of using them in a hot-wire system for any of brazing, cladding, building up, filling, hard-facing overlaying, joining and welding applications.

### BACKGROUND

It is often desirable to use specific materials in a welding or overlaying process to achieve a desired chemistry or physical characteristics. However, sometimes it is desirable to use materials which do not transfer well through a high temperature arc (in traditional arc welding or arc overlaying operations) because the material can decompose, oxidize, etc. Furthermore, sometimes it can be difficult to create a consumable utilizing the desired materials in the appropriate particle size and density. Therefore, it is desirable to have a consumable with the flexibility

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method for creating a molten puddle with at least one high intensity energy source and determining an upper threshold value to prevent an arc from being formed between the wire and the puddle. A filler wire having a core and filler matrix adhered to an outer surface of the core is directed to the molten puddle and both of the filler matrix and the core are electrically conductive. The filler wire is heated with a filler wire heating signal from a power source to a temperature such that the filler wire melts in the puddle when the filler wire is in contact with the molten puddle. Contact is maintained between the filler wire and the molten puddle during the depositing of the filler wire, and during the process a feedback from the filler wire heating signal is monitored such that the filler wire heating signal is shut off (or modified to prevent arcing) when the upper threshold value is reached by the filler wire heating signal so that no arc is generated between the filler wire and the puddle. The filler wire heating signal is then turned back on to continue heating the filler wire. The filler matrix has electrically conductive particles to be deposited into the molten puddle.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, and hard-facing overlaying applications;

FIGS. 2A through 2E illustrate exemplary embodiments of a consumable which can be used with the system shown in FIG. 1; and

FIG. 3 illustrates the consumable from FIG. 2D passing through a contact tip from the system of FIG. 1.

### DETAILED DESCRIPTION

The term “overlaying” is used herein in a broad manner and may refer to any applications including brazing, cladding, building up, filling, and hard-facing. For example, in a “brazing” application, a filler metal is distributed between closely fitting surfaces of a joint via capillary action. Whereas, in a “braze welding” application the filler metal is made to flow into a gap. As used herein, however, both techniques are broadly referred to as overlaying applications.

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a laser subsystem capable of focusing a laser beam 110 onto a workpiece 115 to heat the workpiece 115. The laser subsystem is a high intensity energy source. The laser subsystem can be any type of high energy laser source, including but not limited to carbon dioxide, Nd:YAG, Yb-disk, Yb-fiber, fiber delivered or direct diode laser systems. Further, even white light or quartz laser type systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm². The laser subsystem includes a laser device 120 and a laser power supply 130 operatively connected to each other. The laser power supply 130 provides power to operate the laser device 120.

The system 100 also includes a hot filler wire feeder subsystem capable of providing at least one resistive filler wire 140 to make contact with the workpiece 115 in the vicinity of the laser beam 110. Of course, it is understood that by reference to the workpiece 115 herein, the molten puddle is considered part of the workpiece 115, thus reference to contact with the workpiece 115 includes contact with the puddle. The hot filler wire feeder subsystem includes a filler wire feeder 150, a contact tube 160, and a hot wire power supply 170. During operation, the filler wire 140, which leads the laser beam 110, is resistance-heated by electrical current from the hot wire welding power supply 170 which is operatively connected between the contact tube 160 and the workpiece 115. In accordance with an embodiment of the present invention, the hot wire welding power supply 170 is a direct current (DC) power supply, although alternating current (AC) or other types of power supplies are possible as well. The wire 140 is fed from the filler wire feeder 150 through the contact tube 160 toward the workpiece 115 and extends beyond the tube 160. The extension portion of the wire 140 is resistance-heated such that the extension portion approaches or reaches the melting point before or at contacting a weld puddle on the workpiece. The laser beam 110 serves to melt some of the base metal of the workpiece 115 to form a weld puddle and also to melt the wire 140 onto the workpiece 115. The power supply 170 provides a large portion of the energy needed to resistance-heat the filler wire 140. The feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece.

The system 100 further includes a motion control subsystem capable of moving the laser beam 110 (energy source) and the resistive filler wire 140 in a same direction 125 along the workpiece 115 (at least in a relative sense) such that the laser beam 110 and the resistive filler wire 140 remain in a fixed relation to each other. According to various embodiments, the relative motion between the workpiece 115 and the laser/wire combination may be achieved by actually moving the workpiece 115 or by moving the laser device 120 and the hot wire feeder subsystem. In FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the wire 140 effectively travel along the workpiece 115. In accordance with an alternative embodiment of the present invention, the laser device 110 and the contact tube 160 may be integrated into a single head. The head may be moved along the workpiece 115 via a motion control subsystem operatively connected to the head.

In general, there are several methods that a high intensity energy source/hot wire may be moved relative to a workpiece. If the workpiece is round, for example, the high intensity energy source/hot wire may be stationary and the workpiece may be rotated under the high intensity energy source/hot wire. Alternatively, a robot arm or linear tractor may move parallel to the round workpiece and, as the workpiece is rotated, the high intensity energy source/hot wire may move continuously or index once per revolution to, for example, overlay the surface of the round workpiece. If the workpiece is flat or at least not round, the workpiece may be moved under the high intensity energy source/hot wire as shown if FIG. 1. However, a robot arm or linear tractor or even a beam-mounted carriage may be used to move a high intensity energy source/hot wire head relative to the workpiece.

The system 100 further includes a sensing and current control subsystem 195 which is operatively connected to the workpiece 115 and the contact tube 160 (i.e., effectively connected to the output of the hot wire power supply 170) and is capable of measuring a potential difference (i.e., a voltage V) between and a current (I) through the workpiece 115 and the hot wire 140. The sensing and current control subsystem 195 may further be capable of calculating a resistance value (R=V/I) and/or a power value (P=V*I) from the measured voltage and current. In general, when the hot wire 140 is in contact with the workpiece 115, the potential difference between the hot wire 140 and the workpiece 115 is zero volts or very nearly zero volts. As a result, the sensing and current control subsystem 195 is capable of sensing when the resistive filler wire 140 is in contact with the workpiece 115 and is operatively connected to the hot wire power supply 170 to be further capable of controlling the flow of current through the resistive filler wire 140 in response to the sensing, as is described in more detail within the application incorporated herein by reference, in its entirety. Specifically, the heating current is controlled such that there is no arc generated between the wire 140 and the puddle and the current is controlled such that when an arc is detected, or when a threshold value (voltage, current and/or power) is reached the heating current is either shut off or modified such that no arc is generated. In accordance with another embodiment of the present invention, the sensing and current controller 195 may be an integral part of the hot wire power supply 170.

In accordance with an embodiment of the present invention, the motion controller 180 may further be operatively connected to the laser power supply 130 and/or the sensing and current controller 195. In this manner, the motion controller 180 and the laser power supply 130 may communicate with each other such that the laser power supply 130 knows when the workpiece 115 is moving and such that the motion controller 180 knows if the laser device 120 is active. Similarly, in this manner, the motion controller 180 and the sensing and current controller 195 may communicate with each other such that the sensing and current controller 195 knows when the workpiece 115 is moving and such that the motion controller 180 knows if the hot filler wire feeder subsystem is active. Such communications may be used to coordinate activities between the various subsystems of the system 100.

Of course, the above discussion is general in nature and the system 100 can have various other functions and configurations, as described in U.S. patent application Ser. No. 13/547,649, filed on Jul. 12, 2012, which is incorporated herein by reference in its entirety. Specifically, the present application incorporates the detailed discussions of the operation and structure of the hot-wire systems, and more specifically the methods and systems to control the heating current for the wire 140, disclosed in each of FIGS. 1-5, 11A-15, 17-18, and 20-27, such that no arc is formed between the wire and a puddle on the workpiece.

Turning now to FIGS. 2A-2E, various embodiments of a consumable that can be used with the above referenced system 100 are shown. Specifically, FIG. 2A shows an embodiment of a wire 140 having a solid metal core 141 and a filler material matrix 143 surrounding the core 141. The outer diameter of the wire 140 is typically similar to that known welding consumables, for example in the range of 0.035 to 0.065 inches, so that existing welding wire feed systems can be utilized. Of course, embodiments of the present invention, can utilize larger diameter consumables as needed.

The core 141 is made of an electrically conductive metal that has a chemistry and composition consistent with the desired cladding or joint chemistry desired. For example, the core 141 can be made from mild steel, stainless steel, aluminum, etc. Typically, the core 141 has a maximum cross-sectional area which is in the range of 5 to 45% of the overall cross-sectional area of the wire 140. In other exemplary embodiments, the maximum cross-sectional area of the core is in the range of 5 to 25% of the cross-sectional area or the wire 140. Of course other cross-sectional area ratios can be utilized, but by maintaining the ratio in the range of 5 to 45% the core 141 can provide the needed support for the matrix 143 while minimizing the consumption of the overall volume of wire taken up by the core 141.

The filler material matrix 143 is placed on the core and has a composition consistent with the desired joint or cladding chemistry. For example, in some exemplary embodiments of the present invention, the matrix 143 is comprised of a binder and metal particles 144 which are desired to be deposited in the molten puddle. Typically, the binder can be any known binder material commonly used in the manufacture of stick electrodes and can include polymeric or organic materials. As such materials are generally known they need not be described in detail herein.

The metal particles 144 are of a metallic material having a composition which is desired to be deposited into the weld puddle to form a weld bead or a cladding layer, as desired. Because of the various advantages of using a hot-wire system as described above, the particles 144 can be a composition which do not normally transfer through a welding arc during an arc welding process. For example, the particles 144 can be made from a carbide material, such as tungsten carbide for hard facing a workpiece. The particles 144 can also be of any other type of material that is desired to be deposited into the puddle created during utilization of the system 100 described above. Other examples of the materials used for particles 144 include other carbides such as chromium carbides.

Further exemplary embodiments of the present invention include a wire 140 that utilizes a mixture of particles 144 having different compositions. For example, embodiments can have particles with any combination of two, three or more different particle compositions—in desired ratio amounts. This allows consumables of the present invention to be customized to a particular application, without regard to the concerns normally accompanied with using an arc process for deposition.

Advantages of the present invention, allow the utilization of particles 144 that have a size which normally cannot be used with a traditional consumable construction. For example, in embodiments of the present invention, the particles of a nominal diameter in the range of 0.05 mm to 0.5 mm. In other exemplary embodiments the particles 144 can have a nominal diameter in the range of 0.125 mm to 0.3 mm. In some embodiments, the particle size can be in the range of 0.3 to 0.5 mm, when larger particles sizes are desired. Thus, embodiments of the present invention allow for the utilization of particles 144 having a size much larger than can be used in a cored wire. In some embodiments, all of the particles 144 in the matrix will be in the ranges set forth above, for the respective ranges. However, in other exemplary embodiments, the matrix 143 can contain particles 144 of varying nominal diameters, spread across the ranges identified above, depending on the desired deposit characteristics.

Because the system 100 heats the wire 140 with an electrical current, as described above, the particles 144 are to be electrically conductive and the matrix 143 is to have sufficient particle density so as to allow the electrical heating current to be sufficiently transferred to particles 144 internal in the matrix and to the core 141 so as to sufficiently heat the wire 140 for proper consumption in the molten puddle with the system 100. That is, the particles 144 are to have a density—within the matrix 143—such that a sufficient number of particles 144 are in contact with each other so as to transfer the heating current within the wire 140 for proper melting. Embodiments can use particles of varying nominal diameters so as to maximize density. In exemplary embodiments of the present invention, the matrix has a volumetric particle density in the range of 5 to 80%. That is, various particle densities can be used based on the desired particle usage in the deposit. When low volume percentage is needed in the deposit the volumetric particle density can be low, such as in the range of 5 to 30%. In other exemplary embodiments, when it is desired to have a large amount of particles in the deposit the volumetric particle density within the matrix is in the range of 50 to 75%.

In some exemplary embodiments, the matrix 143 has a volumetric particle density which provides a sufficient level of conductivity in the matrix to ensure sufficient current flow. In some exemplary embodiments, the volumetric particle density of the matrix 143 is such that the matrix has a conductivity value (Siemens/meter) which is at least 45% of the conductivity of the material of the least conductive particles 144 within the matrix. (Of course, if the particles 144 have all the same composition then the matrix conductivity is to be at least 45% of the conductivity of the material of the particles 144). That is, if the conductivity of material composition of the particles 144 is “XX” Siemens/meter, than the volumetric particle density of the matrix 143 is such that the conductivity of the matrix 143 is at least 0.45XX. In other exemplary embodiments, the conductivity value of the matrix 143 is in the range of 55 to 90% of the conductivity value of the material of the least conductive particles 144.

In further exemplary embodiments of the present invention, the core 141 of the wire 140 has a resistance which is less than that of the matrix 143. In such embodiments, the lower resistance level of the core 141 will draw current from the matrix 143 to the core 141 to aid in its heating/melting. In exemplary embodiments of the present invention, the core has a resistance (ohms) that is in the range of 25 to 95% of the resistance of the matrix 143. In other exemplary embodiments, the resistance of the core 141 is in the range of 65 to 90% of the matrix.

In some exemplary embodiments of the present invention, the binder of the matrix 143 is also conductive, and can have conductive components to it. For example, the binder can be comprised of a metal powder that is conductive, to aid in providing the conductivity of the matrix 143. For example, in some exemplary embodiments the matrix can have an iron powder. Of course, other conductive metallic powders can be used as desired. The metallic powder can contribute to the conductivity of the matrix to ensure sufficient current flow in the wire 140 for proper melting. Other examples of metallic powder that can be used in the binder of the matrix 143 can be nickel, chromium, and/or molybdenum. Of course, the binder can also be comprised of a mixture of different powders, including a mixture of any two (or more) of iron, nickel, chromium, and/or molybdenum, depending on the desired joint/clad chemistry.

Based on the foregoing, one exemplary embodiment of the present invention is a wire 140 with tungsten carbide particles 144 in a nickel-chromium powder based matrix 143, while in another exemplary embodiment the wire 140 uses chromium carbide particles 144 in a stainless steel powder based matrix 143. The particles can also be iron oxides or iron carbides in some embodiments.

FIG. 2B depicts another exemplary embodiment of the wire 140 of the present invention. In this embodiment the core 141 has at least one protrusion portion 145 which extends into the matrix 143. The protrusion portion(s) 145 extend into the matrix 143 to increase adhesion between the matrix 143 and increase the surface contact area with the matrix 143 to increase electrical contact between the matrix 143 and the core 141. Increasing electrical contact can allow for the more efficient melting of the core in a hot-wire process using the system 100. The protrusion(s) can be any desired shape and length, and embodiments of the present invention are not limited in this regard. In some exemplary embodiments, the protrusion(s) 145 run the length of the core 141 and extend in the range of 35 to 55% of the distance between the outer surface S of the core 141 and the outer edge E of the wire 140. Furthermore, it is noted that embodiments of the present invention are not limited by the shape of the core 141. For example, the core can be square, rectangular, polygonal, etc. without departing from the spirit and scope of the present invention.

FIG. 2C depicts another exemplary embodiment of the present invention, where the core 141 is shaped as a bar extending through the wire 140 such that the core 141 has at least one exposed edge(s) 142′ and 142″ on the outer diameter of the wire 140. (It is noted that in FIG. 2C the embodiment has two exposed edges 142′ and 142″, but embodiments can only utilize one, or can have more than two if needed). In some exemplary embodiments of the invention it may be desirable to have direct electrical contact between the core 141 and the contact tube 160. In such embodiments, the conductivity of the matrix 143 may be low, or it may be desirable to heat the core 141 more efficiently. In embodiments of the type shown in FIG. 2C, at least one of the edges 142′ and 142″ will make electrical contact with the contact tube 160 during feeding and thus directly transfer electrical current into the core 141. Of course, other shapes than a bar shape (as shown) can be utilized.

Further, the exemplary embodiment of FIG. 2C allows for two different matrix compositions to be utilized. Specifically, as the core 141 divides the wire 140 into two portions, one portion of the matrix 143′ can have a first composition, while the second portion 143″ can have a second composition. That is, each of the portions 143′ and 143″ can have different particles 144′ and 144″ (different sizes and/or composition), different volumetric particle density etc. This allows for the increased utilization flexibility of the wire 140. It is also noted that because this embodiment provides a current path between the contact tube 160 and the core 141 directly, the matrix 143 can have reduced or little conductivity. In such an embodiment, the core 141 can be directly heated via contact with the tube 160 and thus the conductivity of the matrix 143 can be less than in those embodiments with no direct current path to the core 141. In fact, in such embodiments the matrix 143 can have little or no conductivity. In some exemplary embodiments, where the core 141 has a direct current path to the contact tube 160, the conductivity of the matrix 143 is in the range of 0 to 20% of the conductivity of the least conductive particles 144 in the matrix 143.

FIG. 2D depicts an embodiment similar to that shown in FIG. 2C, however in this embodiment the core 141 has at least one projection portion 141A which extends beyond the outer diameter of the wire 140. The projection portion can be used to guide the wire 140b through the contact tube 160 so that the wire exits the tube 160 at a desired orientation. Specifically, it may be desired to ensure that the wire 140 enters the puddle at a specific orientation—particularly if the composition of the matrix 143′ is different than the matrix 143″. Further, the protrusion 141A can also ensure proper and consistent electrical contact between the core 141 and the tube 160.

FIG. 2E depicts another exemplary embodiment of the wire 140 of the wire of the present invention. This embodiment is similar to that described in FIG. 2B however in this embodiment, the protrusions 147 do not extend along the entire length of the core 141, but are intermittent along the length of the core 141. Furthermore, in some exemplary embodiments the protrusions 147 can extend radially around the entire diameter of the core 141, or only extend partially around the core in a radial direction. Again, such protrusions can be used to improved matrix adhesion and electrical conductivity between the core 141 and the matrix. Furthermore, the protrusions 147 can be used to vary the cross-sectional area of the core 141 along its length. This will aid in preventing an arc from being created between the wire 140 and the workpiece. The changes in the cross-sectional area will result in changes in the resistance of the wire 140 along its length, thus aiding in preventing arcing as the wire 140 is heated to or near its melting temperature.

FIG. 3 illustrates an exemplary embodiment of the wire 140 from FIG. 2D passing through a contact tube 160 having a groove 161 to receive the protrusion 141A to maintain the wire 140 at the desired orientation. Specifically, it may be desirable to have the wire 140 enter the puddle with the core 141 oriented vertically or horizontally (as shown) and thus the protrusion 141A and the groove 161 maintain the desired orientation. The construction and materials of the contact tube 160 can be similar to that of known welding contact tips, except with the presence of the groove 161 for the embodiment shown in FIG. 3.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A method of depositing a material, comprising:
creating a molten puddle with at least one high intensity energy source;
determining an upper threshold value;
directing at least one filler wire having a core and filler matrix adhered to an outer surface of said core to said molten puddle, where both of said filler matrix and said core are electrically conductive;
heating said at least one filler wire with a filler wire heating signal from a power source to a temperature such that said filler wire melts in said molten puddle when said filler wire is in contact with said molten puddle;
maintaining contact between said filler wire and said molten puddle during the depositing of said filler wire;
monitoring a feedback from said filler wire heating signal;
modifying said filler wire heating signal when said upper threshold value is reached by said filler wire heating signal such that no arc is generated between said filler wire and said molten puddle; and
turning on said filler wire heating signal to continue heating said filler wire,
wherein said filler matrix comprises electrically conductive particles to be deposited into said molten puddle.

2. A consumable for a hot wire deposition process, comprising:
a solid metallic core having an outer surface;
a matrix deposited onto said outer surface of said metallic core, said matrix comprising a binder and particles,
wherein said binder is either an organic or polymeric binder, and
said particles are electrically conductive and have a nominal diameter in the range of 0.05 mm to 0.5 mm.

3. The consumable of claim 2, wherein said particles are at least one of tungsten carbide and chromium carbide.

4. The consumable of claim 2, wherein said particles have a nominal diameter in the range of 0.125 mm to 0.3 mm.

5. The consumable of claim 2, wherein said particles have a nominal diameter in the range of 0.3 mm to 0.5 mm.

6. The consumable of claim 2, wherein said particles are distributed throughout said matrix such that said matrix has a particle density to allow said matrix to be electrically conductive.

7. The consumable of claim 2, wherein said matrix has a volumetric particle density in the range of 5 to 80%.

8. The consumable of claim 2, wherein said matrix has a volumetric particle density in the range of 5 to 30%.

9. The consumable of claim 2, wherein said matrix has a volumetric particle density in the range of 50 to 75%.

10. The consumable of claim 2, wherein a maximum cross-sectional area of said core is in the range of 5 to 45% of a maximum cross-sectional area of said consumable.

11. The consumable of claim 2, wherein a maximum cross-sectional area of said core is in the range of 5 to 25% of a maximum cross-sectional area of said consumable.

12. The consumable of claim 2, wherein said matrix has a conductivity which is at least 45% of the conductivity of the least conductive of said particles in said matrix.

13. The consumable of claim 2, wherein said matrix has a conductivity which is in the range of 55 to 90% of the conductivity of the least conductive of said particles in said matrix.

14. The consumable of claim 2, wherein said core has a resistance which is less than that of the matrix.

15. The consumable of claim 2, wherein said core has a resistance in the range of 25 to 95% of the resistance of said matrix.

16. The consumable of claim 2, wherein said core has a resistance in the range of 65 to 90% of the resistance of said matrix.

17. The consumable of claim 2, wherein said matrix further comprises a metallic powder within said binder which is conductive.

18. The consumable of claim 17, wherein said metallic powder is any combination of two or more of iron, nickel, chromium and molybdenum.

19. The consumable of claim 17, wherein said particles are tungsten carbide and said metallic powder is a combination of nickel and chromium powder.

20. The consumable of claim 17, wherein said particles are chromium carbide and said metallic powder is a stainless steel based powder.

21. The consumable of claim 2, wherein said core has a protrusion portion that extends beyond a surface of said core and into said matrix.

22. The consumable of claim 21, wherein said protrusion portion runs along an entire length of said core.

23. The consumable of claim 2, wherein said core comprises a plurality of protrusion portions which extend from a surface of said core into said matrix.

24. The consumable of claim 21, wherein said protrusion portion extends into said matrix by a distance in the range of 35 to 55% of the distance between said outer surface of said core and an external surface of said consumable.

25. The consumable of claim 2, wherein said core has at least one exposed surface on an outer edge of said consumable.

26. The consumable of claim 2, wherein said core has at least two exposed surfaces on an outer edge of said consumable.

27. The consumable of claim 26, wherein said core is a plate running through said consumable.

28. The consumable of claim 2, wherein said matrix is comprised of at least two separate matrix portions, where a first of said matrix portions has a different composition from a second of said matrix portions.

29. The consumable of claim 25, wherein said matrix has a conductivity in the range of 0 to 20% of the conductivity of the least conductive of said particles.

30. The consumable of claim 26, wherein said matrix has a conductivity in the range of 0 to 20% of the conductivity of the least conductive of said particles.

31. The consumable of claim 2, wherein said core has at least one projection portion which extends beyond an outer surface of said consumable.
